(19) United States
(12) Patent Application Publication
(10) Pub. No.: US 2003/0000215 A1
(43) Pub. Date: Jan. 2, 2003

(54) Method and device for evacuating a turbine condenser

(76) Inventors: Thomas Koenig, Goerlitz (DE); Wolfgang Lehmann, Goerlitz (DE)

Correspondence Address: HARNESS, DICKEY & PIERCE, P.L.C., P.O.BOX 8910, RESTON, VA, 20195, US

(21) Appl. No.: 10/203,385

(22) PCT Filed: Dec. 20, 2000
(86) PCT No.: PCT/EP00/13039

(51) Int. Cl. F02B 1/00

(52) U.S. Cl. 60/721

(57) ABSTRACT

In order to evacuate a turbine condenser, air (L) contained in the turbine condenser (1) is suctioned using propellant steam from a starting jet pump (19). According to the invention the propellant steam (D) and the air (L) are guided into an auxiliary condenser (5) which is arranged downstream from said turbine condenser (1).

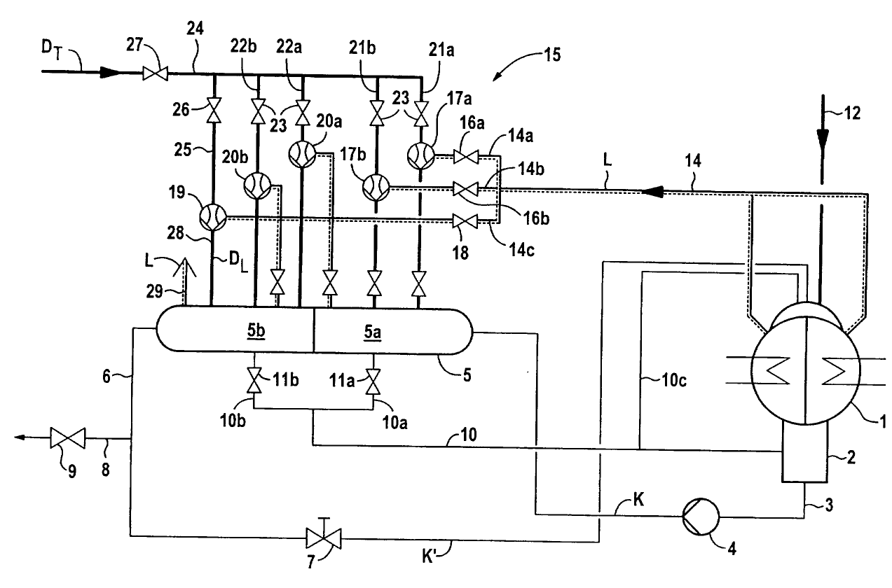

The invention relates to a method for evacuating a turbine condenser, particularly during the starting operation. It also relates to a device for carrying out the method.

During the operation of a steam turbine installation, the steam, which is generally produced in a steam generator and expanded in a steam turbine to produce work, is condensed in a condenser connected downstream of the steam turbines. The condensate which appears in the turbine condenser is returned to the water/steam circuit of the steam turbine. In order to extract air contained in the turbine condenser or main condenser during the operation of the turbine installation, so-called operational jet pumps are frequently employed. These are joined to a propellant steam main and are connected to an auxiliary condenser connected downstream of the main condenser. Air mains connected to the main condenser are joined to the suction side of the operational jet pumps, which operate on the jet pump principle.

During the starting or restarting of the steam turbine, it is necessary to first evacuate the turbine condenser or main condenser. During this operation, the turbine condenser, and therefore the steam turbine installation, is evacuated from 1.0 bar down to approximately 0.3 bar within, for example, half an hour, by means of a so-called starting steam ejector, to which propellant steam is in turn admitted according to the jet pump principle. The steam/air mixture leaving the pressure side of the starting jet pump is conveyed to the open air via a pipeline. In this arrangement, the pipeline must be designed for the mixed temperature which occurs in the steam/air mixture and it is to be equipped with a noise suppressor because of environmental requirements which have to be met.

The essential disadvantage of this arrangement is that the propellant steam, which is usually extracted from the water/steam circuit of the steam turbines, is lost so that the feed water circuit of the turbine condenser has to be topped up by a corresponding quantity of feed water. This loss of feed water increases with increasing number of starting procedures and involves additional costs for the feed water treatment necessary.

The invention is therefore based on the object of providing a method for evacuating a turbine condenser, in particular during the starting operation, by means of which the disadvantages mentioned are avoided in a particularly simple manner. In addition, a device which is particularly suitable for carrying out the method is to be provided.

With respect to the method, the object quoted is achieved, according to the invention, by means of the features of claim 1. For this purpose, the propellant steam conducted via the starting jet pump is together with the air extracted from the turbine condenser introduced into the auxiliary condenser.

By this means, the propellant steam condensing in the auxiliary condenser is again supplied as condensate to the feed water circuit of the turbine condenser and, therefore, to the steam turbine installation. The air contained in the propellant steam is expediently removed from the auxiliary condenser.

In order to additionally permit a starting operation lasting several hours, at least half of the condensate quantity or feed water quantity corresponding to the nominal operation is expediently made available for cooling in the auxiliary condenser. This only requires a corresponding design of a control valve which adjusts, in the usual manner, the condensate flow from the main condenser which is conducted via the auxiliary condenser.

In order, furthermore, to keep the heating of the condensate flow conducted via the auxiliary condenser within necessary limits, a major part, approximately 75%, of the condensate flow conducted by means of a condensate pump via the auxiliary condenser is conducted via the condenser tubes of the main condenser. By this means, the cooling water cooling of the main condenser is used to recool the partial condensate flow conducted via the auxiliary condenser. The relatively small proportion, approximately 25%, of the condensate flow, i.e. of the condensate quantity conveyed per unit time, is therefore available for the cooling, which is also necessary during the starting operation, of the quantities of water removed from the steam turbine.

With respect to the device, the object quoted is achieved, according to the invention, by means of the features of claim 5. Advantageous embodiments are the subject matter of the subclaims which refer back to claim 5.

The advantages achieved by means of the invention consist, in particular, in the propellant steam extracted from the water/steam circuit of a steam turbine, and employed for evacuating a turbine condenser, being resupplied to the circuit by means of its introduction into the auxiliary condenser of a steam turbine installation. This avoids an undesirable topping up of feed water in the circuit. Furthermore, there is an additional saving with respect to a previously usual noise suppressor in the steam jet, air and pump system for removal of air from the turbine and condensate.

An exemplary embodiment of the invention is explained in more detail below using a drawing. In this, the single FIGURE shows, diagrammatically, a turbine condenser with downstream auxiliary condenser and steam jet, air and pump system.

A main condenser or turbine condenser 1 of a steam turbine installation (not shown) is connected at its outlet end by means of its condensate collector 2 to a condensate main 3, which is connected via a condensate pump 4 to the inlet end of an auxiliary condenser 5. At its outlet end, the auxiliary condenser 5 is connected via a condensate main 6 to the main condenser 1. In the condensate main 6, there is a circulation control valve 7 for adjusting the cooling condensate quantity necessary for a starting operation. A circulation main 8 which, for example, conducts condensate to steam generator heating surfaces and has a control valve 9, which is closed during the starting operation, is connected to the condensate main 6.

Condensate K which collects in the auxiliary condenser 5 is conducted via a condensate main 10 into the condensate collector 2 of the main condenser 1. For this purpose, the condensate main 10 is connected via two branch conduits 10a and 10b (in which there are respective shut-off valves 11a, 11b) to a first pressure stage 5a or to a second pressure stage 5b of the auxiliary condenser 5. A branch conduit 10c (which is used for the return of condensate) of the condensate main 10 leads into the main condenser 1, into which an exhaust steam main 12 from the steam turbine (not shown) opens.

Three partial mains 14a, 14b and 14c of a steam/air mixture pipeline 14, which is common to them, are connected to the main condenser 1. This pipeline 14 leads to a jet pump system 15 for evacuating or deaerating the main condenser 1 and, therefore, the turbine installation (not shown). For this purpose, the main 14 leads via a respective shut-off valve 16a, 16b to an operational jet pump 17a or 17b of the first pressure stage 5a of the auxiliary condenser 5. The main 14, which is connected to the main condenser 1, leads to a starting jet pump 19 via the partial main 14c, in which there is, in turn, a shut-off valve 18. This starting jet pump 19 is associated with the second pressure stage 5b of the auxiliary condenser 5.

The first and second pressure stages 5a, 5b of the auxiliary condenser 5 are respectively associated with a further operational jet pump 20a or 20b. The operational jet pumps 17a, 20a and 17b, 20b are embodied so as to provide redundancy.

The operational jet pumps 17a, 17b and 20a, 20b are respectively joined to a common propellant steam main 24 via branch mains 21a, 21b and 22a, 22b, in each of which there is a shut-off valve 23. The starting jet pump 19 is likewise joined to the propellant steam main 24 via a branch main 25, in which there is, in turn, a shut-off valve 26. A further shut-off valve 27 is located in the propellant steam main 24, propellant steam D_{T} conducted via this shut-off valve 27 being extracted, in a manner not shown in any more detail, from a water/steam circuit of the steam turbine.

During a starting operation of the steam turbine installation, the turbine condenser 1 is first evacuated. For this purpose, propellant steam D_{T} is conducted via the branch main 25 and via the starting jet pump 19 with the shut-off valves 27 and 26 open. The quantity of propellant steam D_{T} conducted via the propellant steam main 24 and via the branch main 25 per unit time during the starting operation is determined by means of the starting jet pump 19. The propellant steam D_{T} conducted via the starting jet pump 19, which operates on the jet pump principle, is (together with the air L which is extracted from the main condenser 1, via the air main 14, as a consequence of the depression which builds up within the main condenser 1) introduced as a steam/air mixture DL into the auxiliary condenser 5. For this purpose, the pressure end of the starting jet pump 19 is preferably connected via a connecting main 28 to the second pressure stage 5b of the auxiliary condenser 5. While the propellant steam D_{T} is condensing in the auxiliary condenser 5, the air L entrained by the propellant steam D_{T} is led away, out of the auxiliary condenser 5, via a deaeration main 29 to the atmosphere. The propellant steam D_{T} which condenses in the auxiliary condenser 5 is introduced as condensate via the condensate main 10 into the condensate collector 2 of the main condenser 1 and, therefore, into its circuit.

In order to condense the propellant steam D_{T} in the auxiliary condenser 5, a partial flow of condensate K from the main condenser 1 conveyed via the condensate pump 4 is supplied to the auxiliary condenser 5 as cooling water. The cooling water K′, which is heated during the heat exchange with the propellant steam D within the auxiliary condenser 5, leaves the auxiliary condenser 5 via the condensate main 6. The setting valve or control valve 7 is used for adjusting the quantity of the condensate partial flow or cooling water K′ conducted via the auxiliary condenser 5 per unit time. During the starting operation, the quantity of the cooling water K′ is adjusted to approximately 50% to 70% of the nominal condensate quantity.

The operational jet pumps 17a, 17b and 20a, 20b, which are embodied so as to provide redundancy and of which, for example, the jet pumps 17a and 20a operate during the normal operation of the steam turbine installation whereas the two jet pumps are in standby operation, operate on the jet pump principle, like the starting jet pump 19. Whereas the starting jet pump 19 is used for evacuating the main condenser 1 during the starting of the steam turbine installation, the operational jet pumps 17a, 20a or 20a, 20b extract air L which appears in the main condenser 1 during the normal operation of the steam turbine installation.

1. A method for evacuating a turbine condenser (1), in which air (L) contained in the turbine condenser (1) is extracted by means of propellant steam (D) conducted via a starting jet pump (19) and this air (L), together with the propellant steam (D), is conducted into an auxiliary condenser (5) connected downstream of the turbine condenser (1).

2. The method as claimed in claim 1, in which the propellant steam (D) condenses in the auxiliary condenser (5) and the condensate (K) is supplied to the turbine condenser (1).

3. The method as claimed in claim 1 or 2, in which the air (L) is removed from the auxiliary condenser (5).

4. The method as claimed in one of claims 1 to 3, in which an adjustable partial condensate flow (K′) is conveyed out of the turbine condenser (1) via the auxiliary condenser (5).

5. A device for evacuating a turbine condenser (1), in particular in order to carry out the method as claimed in one of claims 1 to 4, which condenser (1) is connected at its outlet end to an auxiliary condenser (5), characterized by a starting jet pump (19), which is connected to a propellant steam main (24) and to the auxiliary condenser (5) at the pressure end and is connected to the air main (14) connected at the suction end to the main condenser (5).

6. The device as claimed in claim 5, characterized in that at least one operational jet pump (17, 20) is connected in parallel with the starting jet pump (19).

7. The device as claimed in claim 6, characterized in that the or each operational jet pump (17a, 17b; 20a, 20b) is embodied so as to provide redundancy.

8. The device as claimed in one of claims 5 to 7, characterized in that the auxiliary condenser (5) is connected, at the inlet end via a condensate pump (4) and at the outlet end via a setting valve (7), to the turbine condenser (1).
